(19) United States
(12) Patent Application Publication
(10) Pub. No.: US 2025/0351006 A1
(43) Pub. Date: Nov. 13, 2025

(54) METHOD FOR RESERVATION-BASED SENSING AND COMMUNICATION SYSTEM PROVIDING THE SAME

(71) Applicant: Electronics and Telecommunications Research Institute, Daejeon (KR)

(72) Inventor: Soohwan LEE, Daejeon (KR)

(73) Assignee: Electronics and Telecommunications Research Institute, Daejeon (KR)

(21) Appl. No.: 19/198,893

(22) Filed: May 5, 2025

(30) Foreign Application Priority Data
May 9, 2024 (KR) 10-2024-0061330
Apr. 29, 2025 (KR) 10-2025-0056650

(51) Int. Cl. H04W 28/18; H04W 4/38; H04W 8/22

(52) U.S. Cl. CPC H04W 28/18; H04W 4/38; H04W 8/22

(57) ABSTRACT

A reservation-based sensing method may comprise receiving, by a core network and using at least one first network function (NF), a sensing request from a sensing client; negotiating, by the core network and using at least one second NF, a sensing policy for performing a sensing operation corresponding to the sensing request with the sensing client; and communicating, by the core network and using the at least one second NF, with a RAN or a UE, so that the sensing operation corresponding to the sensing request is performed by applying the sensing policy determined based on the negotiation, wherein the sensing request includes reservation information for performing the sensing operation.

### CROSS-REFERENCE TO RELATED APPLICATIONS

This application claims priority to Korean Patent Applications No. 10-2024-0061330, filed on May 9, 2024, and No. 10-2025-0056650, filed on Apr. 29, 2025, with the Korean Intellectual Property Office (KIPO), the entire contents of which are hereby incorporated by reference.

### BACKGROUND 1. Technical Field

The present disclosure relates to a field of communication technologies, and more particularly, to a technique for sensing a target using a communication network and providing sensing information through the communication network.

### 2. Related Art

In a wireless communication network, electronic devices such as base stations (BS) and user equipments (UEs) communicate wirelessly to transmit and receive data. Sensing refers to a process of acquiring information on the surroundings of a device. It may also be used to detect various attributes of an object, such as its location, speed, distance, direction, shape, or texture. Such information may be utilized to enhance communication within the network and for other application-specific purposes.

Sensing in communication networks has typically been limited to active sensing techniques accompanied by devices that receive and process radio frequency (RF) sensing signals. Other sensing techniques, such as passive sensing (e.g. radar) and non-RF sensing (e.g. video imaging and other sensors), may address some limitations of active sensing. However, these other techniques are typically implemented as standalone systems separate from communication networks.

The 5G communication system has been designed with a focus on communication functions, and sensing technologies are performed in separate and independent systems. Sensing technologies independent of communication systems cause inefficient use of resources and act as major factors that degrade the reliability and quality of integrated sensing data. Therefore, improvements to address these issues are required.

### SUMMARY

The present disclosure has been devised to address the problems of the related art, and the present disclosure is directed to proposing network functions and procedures for implementing wireless signal-based sensing technology.

The present disclosure is directed to proposing reservation and/or negotiation procedures for performing sensing between an application service requiring sensing and a mobile communication network, in order to efficiently manage use of radio resources required to improve sensing accuracy and a load of the mobile communication network.

The present disclosure is directed to proposing a system architecture for controlling and managing reservation and/or negotiation procedures for performing sensing between a sensing application service and the mobile communication network.

The present disclosure is directed to proposing a method and system architecture for improving both the efficiency and accuracy of sensing by allocating more sensing resources during times of relatively low load in the mobile communication network.

A communication system for providing a reservation-based sensing function, according to an exemplary embodiment of the present disclosure, may comprise: at least one entity, and the at least one entity may comprise: a computer-readable memory storing at least one instruction; and a processor executing the at least one instruction. When executed by the processor, the at least one instruction may cause the at least one entity to perform: receiving, from a sensing client, a sensing request; negotiating, by using at least one network function (NF), a sensing policy for performing a sensing operation corresponding to the sensing request with the sensing client; and communicating with a radio access network (RAN) or a user equipment (UE) using the at least one NF, so that the sensing operation corresponding to the sensing request is performed by applying the sensing policy determined based on the negotiation. The sensing request may include reservation information for performing the sensing operation.

The at least one instruction may cause the at least one entity to perform: transmitting, through at least one first NF, a sensing reservation or negotiation request including the reservation information to at least one second NF; determining, through the at least one second NF, at least one sensing policy candidate in response to the sensing reservation or negotiation request; and transmitting, through the at least one first NF, the at least one sensing policy candidate to the sensing client as a response to the sensing reservation or negotiation request.

The at least one instruction may cause the at least one entity to perform: receiving, through the at least one first NF, the sensing policy determined by the sensing client among the at least one sensing policy candidate, in response to the sensing reservation or negotiation request.

In the determining of the at least one sensing policy candidate, the at least one instruction may cause the at least one entity to perform: determining, using a Network Data Analytics Function (NWDAF), the at least one sensing policy candidate in response to the sensing reservation or negotiation request.

The sensing policy may include information on at least one of a condition or time when sensing is initiated, a condition or time when sensing ends, available resources for sensing, sensing accuracy, sensing resolution, available sensing modes, an interval between sensings, or UE(s) capable of participating in sensing.

The at least one instruction may cause the at least one entity to perform: exchanging, via at least one first NF, at least one sensing policy candidate for performing the sensing operation corresponding to the sensing request between at least one second NF and the sensing client; and communicating, using the at least one second NF, with the RAN or the UE, so that the sensing operation corresponding to the sensing request is performed by applying the sensing policy determined based on the negotiation.

The at least one instruction may cause the at least one entity to perform: retrieving, using a Unified Data Management (UDM) or a Unified Data Repository (UDR), an available sensing policy candidate capable of responding to the sensing request, in order to negotiate the sensing policy with the sensing client.

The at least one instruction may cause the at least one entity to perform: storing and managing, using a Unified Data Management (UDM) or a Unified Data Repository (UDR), the sensing policy determined based on the negotiation.

The at least one instruction may cause the at least one entity to perform: updating or removing, using at least one first NF, the UDM or the UDR, a previously stored sensing policy based on the sensing policy determined based on the negotiation.

The at least one instruction may cause the at least one entity to perform: notifying, using the UDM or the UDR, at least one second NF of a change to a previously stored sensing policy in accordance with the sensing policy determined based on the negotiation.

A sensing policy negotiation method for reservation-based sensing, according to an exemplary embodiment of the present disclosure, may comprise: receiving, by a core network and using at least one first network function (NF), a sensing reservation or negotiation request from a sensing client; determining, by the core network and using at least one second NF, at least one sensing policy candidate in response to the sensing reservation or negotiation request; and transmitting, by the core network and using the at least one first NF, the at least one sensing policy candidate to the sensing client as a response to the sensing reservation or negotiation request.

The sensing policy negotiation method may further comprise: receiving, by the core network and using the at least one first NF, a sensing policy, among the at least one sensing policy candidate, determined by the sensing client as a result of the sensing reservation or negotiation request.

The sensing policy negotiation method may further comprise: communicating, by the core network and using the at least one second NF, with a Radio Access Network (RAN) or a User Equipment (UE) so that sensing is performed by applying the sensing policy determined as the result of the sensing reservation or negotiation request.

The at least one sensing policy candidate may include information on at least one of a condition or time when sensing is initiated, a condition or time when sensing ends, available resources for sensing, sensing accuracy, sensing resolution, available sensing modes, an interval between sensings, or UE(s) capable of participating in sensing.

The determining of the at least one sensing policy candidate may comprise: determining, by the core network and using a Network Data Analytics Function (NWDAF), the at least one sensing policy candidate in response to the sensing reservation or negotiation request.

A reservation-based sensing method, according to an exemplary embodiment of the present disclosure, may comprise: receiving, by a core network and using at least one first network function (NF), a sensing request from a sensing client; negotiating, by the core network and using at least one second NF, a sensing policy for performing a sensing operation corresponding to the sensing request with the sensing client; and communicating, by the core network and using the at least one second NF, with a radio access network (RAN) or a user equipment (UE), so that the sensing operation corresponding to the sensing request is performed by applying the sensing policy determined based on the negotiation, wherein the sensing request may include reservation information for performing the sensing operation.

The negotiating of the sensing policy with the sensing client may comprise: exchanging, by the core network and via the at least one first NF, at least one sensing policy candidate for performing the sensing operation corresponding to the sensing request between the at least one second NF and the sensing client.

The reservation-based sensing method may further comprise: retrieving, by the core network and using a Unified Data Management (UDM) or a Unified Data Repository (UDR), an available sensing policy candidate capable of responding to the sensing request, in order to negotiate the sensing policy with the sensing client.

The reservation-based sensing method may further comprise: storing and managing, by the core network and using a Unified Data Management (UDM) or a Unified Data Repository (UDR), the sensing policy determined based on the negotiation.

The sensing request may include information on at least one of a condition or time when sensing is initiated, a condition or time when sensing ends, available resources for sensing, sensing accuracy, sensing resolution, available sensing modes, an interval between sensings, or UE(s) capable of participating in sensing.

According to exemplary embodiments of the present disclosure, network functions and procedures for implementing wireless signal-based sensing technology can be implemented.

According to exemplary embodiments of the present disclosure, use of radio resources required to improve sensing accuracy and a load of a mobile communication system can be efficiently managed.

According to exemplary embodiments of the present disclosure, reservation and/or negotiation procedures for performing sensing between an application service requiring sensing and the mobile communication network can be implemented.

According to exemplary embodiments of the present disclosure, a system architecture for controlling and managing reservation and/or negotiation procedures for performing sensing between the sensing application service and the mobile communication network can be implemented.

According to exemplary embodiments of the present disclosure, a method and system architecture for improving both the efficiency and accuracy of sensing by allocating more sensing resources during times of relatively low load in the mobile communication network can be implemented.

### BRIEF DESCRIPTION OF DRAWINGS

FIG. 1 is a conceptual diagram illustrating a wireless signal-based sensing service and a core network supporting the service according to an exemplary embodiment of the present disclosure.

FIG. 2 is a conceptual diagram illustrating operations of surrounding infrastructure around the core network of FIG. 1.

FIG. 3 is a conceptual diagram illustrating a communication system in which a reservation-based sensing method and a sensing policy negotiation method for reservation-based sensing are performed, according to an exemplary embodiment of the present disclosure.

FIGS. 4 to 6 are operational flow charts illustrating exemplary embodiments of processes of a reservation-based sensing method and a sensing policy negotiation method for reservation-based sensing according to the present disclosure.

FIGS. 7 and 8 are operational flowcharts illustrating exemplary embodiments of processes of a sensing policy negotiation method for reservation-based sensing according to the present disclosure.

FIG. 9 is an operational flowchart illustrating exemplary embodiments of processes for managing sensing policies for a reservation-based sensing method according to the present disclosure, including storage, update, and removal.

FIG. 10 is a conceptual diagram illustrating an example of a generalized computing system in which an entity within the core network 100 capable of performing at least a portion of the processes of FIGS. 1 to 9, a sensing entity participating in the sensing process in interaction with the core network 100, or a part thereof may be implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even if a technology is known prior to the filing date of the present disclosure, it may be included as part of the configuration of the present disclosure when necessary, and will be described herein without obscuring the spirit of the present disclosure. However, in describing the configuration of the present disclosure, a detailed description on matters that can be clearly understood by those skilled in the art as a known technology prior to the filing date of the present disclosure may obscure the purpose of the present disclosure, so excessively detailed description on the known technology will be omitted.

However, the purpose of the disclosure is not to claim the rights to these known technologies, and the contents of the known technologies may be included as part of the disclosure without departing from the scope of the disclosure.

Hereinafter, exemplary embodiments of the disclosure will be described in more detail with reference to the accompanying drawings. To facilitate an overall understanding in the description of the disclosure, the same reference numerals will be assigned to the same components throughout the accompanying drawings, and redundant descriptions thereof will be omitted.

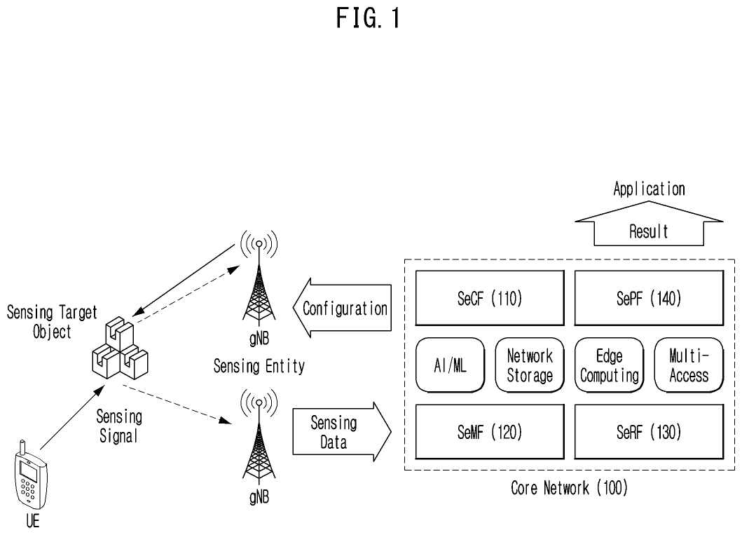

FIG. 1 is a conceptual diagram illustrating a wireless signal-based sensing service and a core network supporting the service according to an exemplary embodiment of the present disclosure.

For the implementation and operation of the exemplary embodiment of FIG. 1, at least a part of integrated sensing and communication (ISAC) technology may be used within a scope not contrary to the objective of the present disclosure.

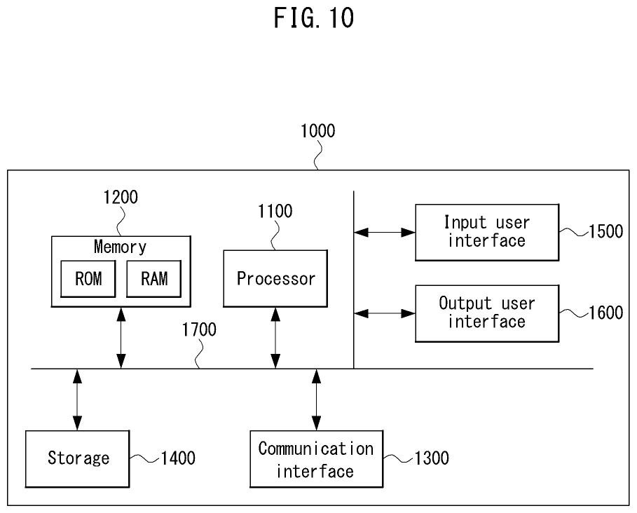

Referring to FIG. 1 and FIG. 10 to be described later, entities in a core network 100 according to an exemplary embodiment of the present disclosure, and/or entities involved in a sensing process by a wireless signal-based sensing service may each include a computer-readable memory 1200 for storing at least one instruction, and a processor 1100 for executing the at least one instruction.

The core network 100 may include various network functions (NFs). Although not illustrated in FIG. 1, the core network 100 may include an Application Function (AF), an Access and Mobility management Function (AMF), an Application Service Provider (ASP), a Location Management Function (LMF), a Network Exposure Function (NEF), an Operation, Administration, and Maintenance (OAM), a Session Management Function (SMF), a Policy Control Function (PCF), a Unified Data Management (UDM), a Unified Data Repository (UDR), a Data Network (DN) or a local part of DN with local access to the data network, a user plane function (UPF), a (Radio) Access Network ((R) AN), and a User Equipment (UE).

Each NF may support the following functions.

The AMF may provide functionality for access and mobility management on a per-UE basis, and one service operated at one UE may be basically connected to one AMF.

The DN may refer to, for example, an operator service, Internet access, or third-party service. The DN may transmit a downlink protocol data unit (PDU) to the UPF or receive a PDU transmitted from the UE via the UPF. The local part of DN may refer to a data network, which is among DN and is locally accessible, with a short data transmission path. The term may refer to a DN where edge application servers supporting edge computing services are deployed.

The PCF may receive information on packet flows for a service from an application server and provide functionality for determining policies such as mobility management and session management for each service. Specifically, the PCF may support functionalities such as providing a unified policy framework for controlling network operations, providing policy rules so that control plane function(s) (e.g. AMF, SMF, etc.) can enforce the policy rules, and implementing a front end for accessing relevant subscription information in the UDR to make policy decisions.

The SMF may provide session management functionality, and when a UE has multiple sessions, the respective sessions may be managed by different SMFs.

The UDM may store in the UDR or provide to other NFs information such as user subscription data, policy data, information on services being used by each users, and information on NF(s) serving each user.

The UDR may store, delete, update, retrieve, and provide to other NFs information such as user subscription data, policy data applicable to services used by each user, device configuration information for user services, and service rule information.

The UPF may deliver a downlink PDU received from the DN to the UE via the (R)AN and deliver an uplink PDU received from the UE via the (R)AN to the DN. An uplink classifier (ULCL) may refer to a UPF that has a functionality of classifying uplink traffic for transmission. A local UPF (L-UPF) may serve as a PDU Session anchor for a session transmitted to the local part of DN.

A Sensing Network Function (SNF) may be an NF supporting ISAC services. The SNF may perform at least one of receiving an ISAC service request, authenticating the request, generating and configuring ISAC service quality control policies, discovering and selecting network device(s) and terminal(s) performing sensing operations, and collecting and processing sensing results. These operations may be configured or implemented as two logically separated NFs: a Sensing Service Gateway/Centre and a Sensing Management Function.

For example, when configured and implemented as logically separated NFs, the Sensing Service Gateway/Centre may be deployed in the mobile communication core network to receive and authenticate ISAC service requests and perform operations such as generating ISAC service quality control policies, while the Sensing Management Function may be deployed in the mobile communication core network to perform operations such as discovering and selecting network device(s) and terminal(s) for performing actual sensing operations and collecting and processing sensing results. The present disclosure does not limit how the Sensing Network Function is configured. That is, both an exemplary embodiment in which the function is configured as a single entity and an exemplary embodiment in which the function is separated into two or more entities are within the scope of the present disclosure. In an exemplary embodiment of the present disclosure, at least a part of the functions of the Sensing Service Gateway/Centre and the Sensing Management Function may be included in the functions of a Sensing Capability Exposure Function (SCEF) and/or a Sensing Service Provisioning Function (SePF), which will be described later.

The UE may be classified into a UE that actually requests an ISAC service and a UE that servers as a sensor detecting a sensing object to provide the ISAC service to the wireless communication system.

A base station of the (R)AN forming a radio access network may perform operations for detecting a sensing object as a sensor, in addition to transmission and reception of communication signals.

To control a quality of an ISAC service according to an exemplary embodiment of the present disclosure, ISAC service quality-related information may be used by the wireless communication system and a device external to the system that requests the ISAC service. To describe exemplary embodiments below, the ISAC service quality-related information may be referred to as ‘Sensing Service Quality (SSQ)’.

Referring again to FIG. 1, the core network 100 according to an exemplary embodiment of the present disclosure may communicate with a sensing apparatus or a sensing device capable of sensing a sensing object (or target) or at least one entity capable of connecting to the sensing device. In this case, the sensing apparatus or the sensing device may be a device separate from a UE or gNB, or may be a UE or gNB itself.

The core network 100 may control, manage, or provide configuration information for sensing devices, as well as configuration information for entities connected to or constituting the sensing devices.

The core network 100 may receive sensing data obtained by the sensing devices through the entities connected to or constituting the sensing devices.

The core network 100 may include a Sensing entity Control network Function (SeCF) 110, a Sensing Management network Function (SeMF) 120, a Sensing Result calculation network Function (SeRF) 130, and a Sensing service Provisioning network Function (SePF) 140.

The core network 100 may provide sensing results obtained using the SeCF 110, the SeMF 120, the SeRF 130, and the SePF 140 to an application.

The core network 100 may provide AI/ML, network storage, edge computing, and/or multi-access functionalities using the SeCF 110, the SeMF 120, the SeRF 130, and the SePF 140.

In the present disclosure, the term ‘sensing entity’ may refer to, for convenience of description, an entity connected to or constituting a sensing device and capable of communicating with the core network 100. The sensing entity may be a device separate from the sensing device or the sensing device itself having a sensing functionality.

The sensing entity may be an entity within the (R)AN. The sensing entity may generally be a 3GPP- or 5G-based entity and may also be a non-3GPP entity.

The sensing entity may generally be deployed in a terrestrial communication network, but the sensing entity may also exist in aerial or satellite communication networks.

The sensing entity may transmit sensing information on a sensing object or sensing target to the core network 100 (or to an entity within the core network 100). In this case, if the sensing device is arranged separately from the sensing entity, sensing information from the sensing device may be delivered to the core network 100 via the sensing entity. If the sensing device has a sensing functionality, sensing information obtained by a sensor module implementing the sensing functionality may be transmitted to the core network 100 via a communication module of the sensing entity.

In addition, the core network 100 (or an entity within the core network 100) may control or manage a sensing process performed by the sensing entity based on the architecture illustrated in FIG. 1. The sensing entity may include a UE or a gNB, and the core network 100 (or an entity within the core network 100) may control or manage the sensing entity to transmit and receive wireless signals for sensing.

The core network 100 (or an entity within the core network 100) may acquire or receive sensing information on the sensing target by cooperating with the sensing entity or utilizing the sensing entity based on the architecture illustrated in FIG. 1.

The sensing entity/equipment/device in a 3GPP network may be a gNB or UE. A non-3GPP sensing device may be a LIDAR, laser, imaging sensor, temperature sensor, or the like using radio access techniques which are not defined by the 3GPP.

In the case where the sensing entity is a gNB or UE in the 3GPP network, wireless signals for sensing the sensing target may use 5G NR or 6G radio access techniques. However, the spirit of the present disclosure is not limited by such an exemplary embodiment.

Operations of the core network 100 may be performed by various NFs within the above-described core network 100. These NFs may be performed by at least one entity within the core network 100, may be performed through cooperation of two or more entities, or individual NFs may be assigned to and performed by individual entities. The spirit of the present disclosure is not limited by the hardware implementation of the NFs within the core network 100.

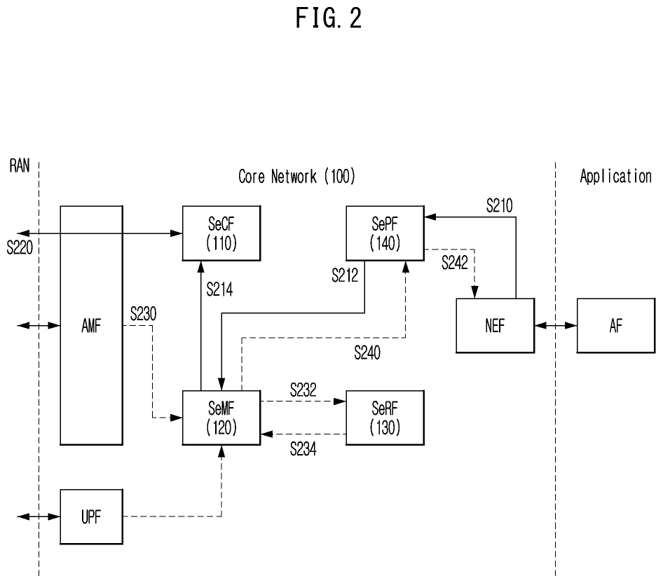

FIG. 2 is a conceptual diagram illustrating operations of surrounding infrastructure around the core network of FIG. 1.

Referring to FIG. 2, the core network 100 may receive a sensing request from an application/sensing service side (S210).

The core network 100 may control a sensing entity within the RAN to transmit sensing reference signals for sensing a sensing object (target) within a sensing space (S220).

When the sensing entity within the RAN receives the sensing signals, the sensing entity may deliver sensing data to the core network 100 (S230). The core network 100 may process the sensing data received from the sensing entity (S232, S234, S240).

The core network 100 may calculate a sensing result based on the sensing data (S232, S234).

The core network 100 may expose the sensing result (S240).

The core network 100 may provide the sensing result (S242).

The NEF within the core network 100 may receive a sensing request via the AF.

The SePF 140 may receive the sensing request via the NEF (S210).

The SePF 140 may deliver the sensing request to the SeMF 120 (S212).

The SeMF 120 may generate and transmit a sensing trigger to the SeCF 110 based on the sensing request (S214).

In this case, the sensing trigger may include a request for configuration information of sensing devices/sensing entities held by the SeCF 110.

The SeCF 110 may communicate with sensing entities within the RAN via the AMF (S220). In step S220, the configuration information held by the SeCF 110 may be delivered to the sensing entities within the RAN. The information delivered in the step S220 may include sensing configuration/policy information and registration information of sensing equipments. The information delivered in the step S220 may be configuration information that enables at least one sensing entity to sense a sensing target.

Additionally or alternatively, the sensing entity may initiate sensing in response to a request from the SeMF 120.

The sensing data obtained by the sensing entity may be delivered to the SeMF 120 via the AMF (S230).

In this case, the UPF may also deliver a part of the sensing data to the SeMF 120.

The SeMF 120 may deliver the sensing data to the SeRF 130 (S232), and the SeRF 130 may calculate a sensing result based on the sensing data and provide the sensing result to the SeMF 120 (S234).

The sensing result may be delivered from the SeMF 120 to the SePF 140 (S240).

The sensing result may be provided to the application side via the SePF 140, the NEF, and the AF (S242).

The SeCF 110 may select an infrastructure (sensing devices) that will transmit sensing wireless signals and control and configure operations of the sensing devices.

The SeMF 120 may collect, store, and transmit the measured sensing data.

The SeRF 130 may calculate the collected sensing data and generate the sensing result as a result of the calculation. The SeRF 130 may inspect the sensing result and manage a quality of the sensing result.

The SePF 140 may invoke or manage sensing-related integrated services. The SePF 140 may also provide the sensing result to an external application.

The core network 100 according to an exemplary embodiment of the present disclosure may include the following new NFs and procedures.

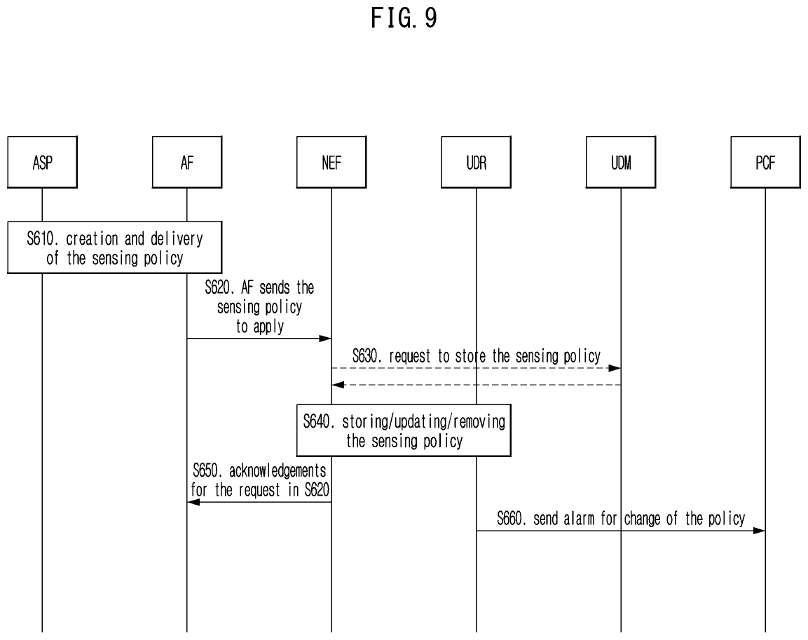

The core network 100 in the exemplary embodiments of FIG. 1 and FIG. 9 to be described later may include the SeCF 110, the SeMF 120, the SeRF 130, and the SePF 140 as new NFs. These NFs are core components for efficiently performing control, processing, calculation, and exposure of sensing data.

The SeCF 110 may define and control the configuration of the sensing entity, the SeMF 120 may collect and pre-process data, the SeRF 130 may analyze the data to generate a result, and the SePF 140 may provide the result to the service. The respective NFs may interact through messages and procedures to manage sensing data in an integrated manner.

The roles of the SeCF 110 are as follows.

The SeCF 110 may perform configuration and control on the sensing entity. The SeCF 110 may manage a configuration between the sensing entity and the sensing device and may configure the sensing entity and the sensing device in association.

Sensing device control and policy configuration: The SeCF 110 may perform detailed configuration of the sensing device operations in terms of time, space, and range, and may define management and sharing policies.

Sensing device selection: The SeCF 110 may select a device or a device group that is to perform transmission and reception of sensing signals. The SeCF 110 may search for and select a sensing entity associated with the sensing device or device group.

The roles of the SeMF 120 are as follows.

The SeMF 120 may perform collection, coordination, processing, and quality of service (QOS) management of the sensing data. The SeMF 120 may comprehensively manage storage and provision of the sensing data.

The SeMF 120 may instruct the sensing entity to perform a sensing operation and may coordinate and manage the sensing operation.

Sensing control flow management: The SeMF 120 may comprehensively manage the sensing control and operation invocation.

Sensing data management: The SeMF 120 may store, manage, and provide sensing data (including raw data), and may evaluate and manage the accuracy and response time of the data. The SeMF 120 may collect and coordinate the sensing data and may manage the quality of the sensing data based on QoS.

Sensing method selection: The SeMF 120 may map a sensing target object and a sensing area and may select an optimal sensing method for the sensing target object and the sensing area.

The roles of the SeRF 130 are as follows.

Sensing result calculation: The SeRF 130 may process sensing data and derive a result by applying filtering and mapping.

Result validity evaluation: The SeRF 130 may validate the sensing result and manage a quality of the result. In this case, the SeRF 130 may evaluate and manage the accuracy and response time of the sensing result for quality management.

The roles of the SePF 140 are as follows.

The SePF 140 may manage a service request and monitor event condition(s) included in the service request.

The SePF 140 may map the sensing result according to the service request and perform authentication and authorization for the service request.

Service request and authentication: The SePF 140 may manage the service request and authenticate and authorize the corresponding request.

Sensing data exposure: The SePF 140 may map the service request and the sensing result and provide them to an application service while maintaining security. The SePF 140 may maintain the security of the sensing data and sensing result and manage privacy.

Through the interaction of these NFs, the core network 100 may integrally manage the processes of sensing data request, control, processing, calculation, exposure, and response. To this end, the NFs may interact through messages and procedures. The core network 100 according to exemplary embodiments of the present disclosure may overcome the limitations of the 5G system and maximize the efficiency of ISAC technology.

In an alternative exemplary embodiment of the present disclosure, the core network may further include a Network Data Analytics Function (NWDAF). The NWDAF may support AI-based analysis. The NWDAF may support preprocessing of sensing data, optimization of device configuration, and enhancement of result calculation efficiency by utilizing AI algorithms.

The NWDAF may analyze data provided by a sensing entity to generate Quality of Service (QOS) improvement information. The QoS improvement information may be delivered to the SeMF 120 and the SeRF 130 to enhance the efficiency of data processing and result calculation.

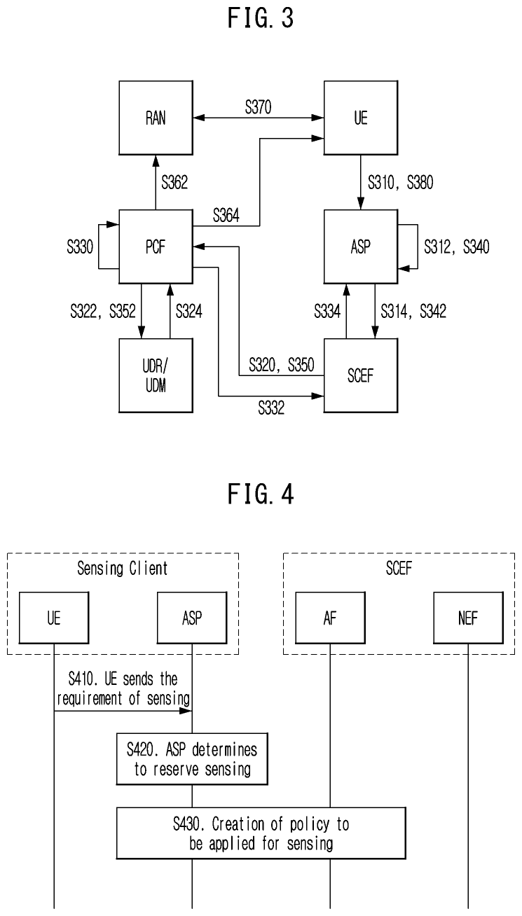

FIG. 3 is a conceptual diagram illustrating a communication system in which a reservation-based sensing method and a sensing policy negotiation method for reservation-based sensing are performed, according to an exemplary embodiment of the present disclosure.

As a frequency band of a mobile communication system expands to a higher frequency band, a bandwidth increases and propagation characteristics of radio waves become more sensitive. The propagation or reflection characteristics of mobile communication radio waves may be utilized to identify a position, shape, and components of a specific object. The present disclosure relates to sensing technology using such radio waves.

The present disclosure provides an effective mobile communication system architecture and control method for performing sensing, and has been derived from an intention to improve the accuracy of radio wave/signal-based sensing.

For sensing, in a mobile communication system, base station(s) and UE(s) may transmit and receive not only communication signals but also additional sensing signals, and a new load for interpreting received signals and transmitting an interpretation result may occur within the mobile communication system.

In particular, in order to improve a sensing resolution, a large number of UEs and base station resources are required, which may increase the load on the mobile communication system. In order to commercialize sensing using wireless signals, a procedure and a system architecture that can manage the load of the mobile communication system efficiently while improving the accuracy of sensing are required.

The present disclosure proposes a comprehensive solution that enables efficient sensing through wireless signals in a mobile communication network. The conventional wireless sensing requires additional frameworks and signals in a cellular network, which may cause significant load and degrade communication performance.

The present disclosure proposes a solution to these problems by reducing a sensing load during high-traffic times through negotiation of sensing times between a sensing application service provider (ASP) and a mobile network operator (MNO), and assigning to sensing requests generating heavy traffic loads to low-traffic times.

The solution of the present disclosure may include: i) an architecture for requesting and negotiating sensing times between the ASP and the MNO, and ii) a wireless sensing negotiation method and procedure between the ASP and the MNO.

According to exemplary embodiments of the present disclosure, use of radio resources required to improve the accuracy of sensing and the load of the mobile communication system can be efficiently managed.

According to exemplary embodiments of the present disclosure, a reservation and/or negotiation procedure for performing sensing can be implemented between a sensing application service and a mobile communication network.

According to exemplary embodiments of the present disclosure, a system architecture for controlling and managing a reservation and/or negotiation procedure for performing sensing between the sensing application service and the mobile communication network can be implemented.

According to exemplary embodiments of the present disclosure, both the efficiency and the accuracy of sensing can be improved by allocating more sensing resources during times of relatively low load in the mobile communication network.

Referring to FIG. 3, a core network that performs a method of controlling sensing for reservation of sensing times and resources through negotiation with the sensing client according to an exemplary embodiment of the present disclosure may include a first NF and a second NF. For convenience of description, in the following description, the SCEF may be referred to as the first NF, and the PCF may be referred to as the second NF.

In an exemplary embodiment of the present disclosure, the first NF may include at least one of the NEF and/or the AF.

In an alternative exemplary embodiment of the present disclosure, the first NF may include the NEF or the AF of FIG. 2 and may include a part of the functions of the SePF 140 of FIGS. 1 and 2.

In an alternative exemplary embodiment of the present disclosure, the second NF may include a part of the functions of the SeCF 110 or the SeMF 120 of FIGS. 1 and 2.

In an alternative exemplary embodiment of the present disclosure, the second NF may include a part of the function of the AMF.

In an alternative exemplary embodiment of the present disclosure, the second NF may further include the UDR and/or the UDM.

In an exemplary embodiment of the present disclosure, a sensing client may include the ASP utilizing sensing services from the mobile communication network. In an alternative exemplary embodiment of the present disclosure, the sensing client may include the ASP and a service implemented in the ASP in the form of the application executed in the UE environment.

A part of the functions of the sensing client may be implemented in form of an application (i.e. App) in the UE and may communicate with the UE, and/or may communicate with the core network through the first NF, and/or may communicate with the core network through the second NF. The sensing client may include the ASP NF.

Referring to FIG. 3 together with FIG. 10 to be described, a communication system providing a reservation-based sensing function according to an exemplary embodiment of the present disclosure may include at least one entity, and the at least one entity may include a computer-readable memory 1200 storing at least one instruction, and a processor 1100 executing the at least one instruction.

The at least one entity may receive a sensing request (for example, related to a target sensing area, object, and/or event) from the sensing client (S314). The at least one entity may negotiate, using at least one NF, a sensing policy for performing a sensing operation corresponding to the sensing request with the sensing client (S320, S330, S340, S350, S332, S334). The at least one entity may also communicate with a radio access network (RAN) or the UE using the at least one NF, so that the sensing operation corresponding to the sensing request is performed by applying the sensing policy determined based on the negotiation (S362, S364).

In this case, the sensing request may include reservation information for performing the sensing operation.

The at least one entity may transmit, using the at least one first NF, a sensing reservation or negotiation request including the reservation information to at least one second NF (S320), may determine, using the at least one second NF, at least one sensing policy candidate in response to the sensing reservation or negotiation request (S330), and may transmit, using the at least one first NF (S332), the at least one sensing policy candidate to the sensing client as a response to the sensing reservation or negotiation request (S334).

The at least one entity may receive, using the at least one first NF, a sensing policy determined by the sensing client from among the at least one sensing policy candidate as a result of the sensing reservation or negotiation request (S342).

The at least one entity may determine, using the policies stored in the UDR, based on the previously reserved sensing policies or the used sensing policies in the past, the at least one sensing policy candidate in response to the sensing reservation or negotiation request (S330).

The at least one entity may determine, using the NWDAF, the at least one sensing policy candidate in response to the sensing reservation or negotiation request (S330). In the communication system according to an exemplary embodiment of the

present disclosure, the sensing policy may include at least one of a condition or time when sensing is initiated, a condition or time when sensing ends, resources available for sensing, sensing accuracy, sensing resolution, possible sensing modes, an interval between sensings, or information on UEs that can participate in sensing.

The at least one entity may exchange the at least one sensing policy candidate for performing the sensing operation corresponding to the sensing request between the at least one second NF and the sensing client via the at least one first NF (S314, S320, S332, S334, S342, S350).

The at least one entity may communicate with the RAN or the UE using the at least one second NF, so that the sensing operation corresponding to the sensing request is performed by applying the sensing policy determined based on the negotiation (S362, S364).

The at least one entity may retrieve, using the UDR or the UDM, available sensing policy candidates corresponding to the sensing request to negotiate the sensing policy with the sensing client (S322, S324).

The at least one entity may store and manage the sensing policy determined based on the negotiation (S340, S342, S350) using the UDR or the UDM (S352).

In this case, the at least one entity may add, update or delete a previously stored sensing policy based on the sensing policy determined through the negotiation using the at least one first NF, the UDR, or the UDM.

In this case, the at least one entity may notify, using the UDR or the UDM, the at least one second NF of the change of the previously stored sensing policy based on the sensing policy determined through the negotiation. The at least one second NF may communicate with the RAN and/or UE to change the current/present sensing policies to the new sensing policies based on the notified changed sensing policies.

The sensing policy negotiation method for reservation-based sensing according to an exemplary embodiment of the present disclosure may comprise: a step S314 and/or S320 in which the core network receives a sensing reservation or negotiation request for a sensing ((for example, for a sensing target area, object, and/or event) from the sensing client using at least one first NF; a step S330 in which the core network determines at least one sensing policy candidate in response to the sensing reservation or negotiation request using at least one second NF; and a step S332 and/or S334 in which the core network transmits the at least one sensing policy candidate to the sensing client as a response to the sensing reservation or negotiation request using the at least one first NF.

In the sensing policy negotiation method for reservation-based sensing according to an exemplary embodiment of the present disclosure, the at least one sensing policy candidate may include a condition or time when sensing is initiated, a condition or time when sensing ends, resources available for sensing, sensing accuracy, sensing resolution, possible sensing modes, an interval between sensings, or information on UEs that can participate in sensing.

The reservation-based sensing method according to an exemplary embodiment of the present disclosure may comprise: the step S314 in which the core network receives a sensing request for a sensing (for example, for a target sensing area, object, and/or event) from the sensing client using at least one first NF; the step S320 or S330 in which the core network negotiates a sensing policy for performing a sensing operation corresponding to the sensing request with the sensing client using at least one second NF; and the step S362 or S364 in which the core network communicate with a RAN or UE using the at least one second NF, so that the sensing operation corresponding to the sensing request is performed by applying the sensing policy determined based on the negotiation.

In the reservation-based sensing method according to an exemplary embodiment of the present disclosure, the sensing request may include reservation information required for performing the sensing operation.

In the reservation-based sensing method according to an exemplary embodiment of the present disclosure, the sensing request may include at least one of: a condition or time when sensing is initiated, a condition or time when sensing ends, resources available for sensing, sensing accuracy, sensing resolution, possible sensing modes, intervals between sensings, or information on UEs that can participate in the sensing.

Referring again to FIG. 3, the sensing system may include one or more UEs, RAN(s), AMF, SeMF, PCF, sensing client, UDM, UDR, and SCEF.

The UE may be a client of a sensing application requesting sensing or may be a sensing entity that participates in sensing to perform the sensing operation corresponding to the sensing request. The UE may participate in sensing for the sensing service that the UE has requested. In this case, the UE may be located within a specific target area designated by the sensing request. The UE may participate in sensing for a sensing service requested by another UE and may provide a sensing measurement result.

The sensing client may include the ASP. The sensing client may receive a sensing request from the UE (S310). In this case, the UE may be a client of the sensing application requesting sensing.

The UE, as a sensing entity, may transmit either processed measurement (e.g. an event inferred from measured data such as movement of a sensing target exceeding a certain range or a shape of the sensing target) or unprocessed measurement (e.g. measured raw data) to the sensing client (S380).

The sensing client may include a sensing measurement analyzer or may interact with the sensing measurement analyzer to process the sensing measurement. For example, the ASP of the sensing client may deliver a set of processed/unprocessed measurements to the sensing measurement analyzer, and the sensing measurement analyzer may deliver an analysis result to the first NF directly, and/or to an application layer of UE via the first NF and/or the UPF. If the UE is a client of the application or service, the analysis result may be delivered to the UE.

The first NF may also deliver a set of processed/unprocessed measurements collected from sensing entities other than the UE shown in FIG. 3 to the sensing measurement analyzer within the sensing client.

When the UE shown in FIG. 3 is a client of the sensing service, the sensing client may deliver the analysis result of the sensing measurement analyzer to the UE as a response to the sensing request of step S310.

The ASP within the sensing client may determine (S312) whether to make a sensing reservation based on the sensing request (S310) from the UE and/or the self determination of the ASP.

The ASP within the sensing client may deliver the sensing request to the first NF together with requirements for the sensing (S314).

The sensing request delivered in step S314 may include a sensing reservation request or a sensing reservation negotiation request.

In an exemplary embodiment in which the first network NF includes the AF and NEF, the AF may transmit a request to reserve a sensing policy to the NEF.

The first NF or the NEF within the first NF may transmit the sensing policy reservation request to the second NF (S320).

The second NF may request retrieval of available sensing policies from the UDR and/or UDM in response to the sensing request or the sensing policy reservation request (S322).

The UDR and/or UDM may store and manage a reserved sensing policy pool.

The UDR and/or UDM may feed back a retrieval result of the available sensing policies from the reserved sensing policy pool to the second NF (S324).

The second NF may determine at least one sensing policy candidate based on the retrieval result of the available sensing policies (S330). In this case, the at least one sensing policy candidate may be an allowed sensing policy in response to the sensing request or sensing reservation negotiation request.

The second NF may deliver the determined at least one sensing policy candidate to the first NF (S332).

The first NF may deliver the determined at least one sensing policy candidate to the ASP within the sensing client (S334).

In an exemplary embodiment in which the first NF includes the AF and NEF, the NEF may deliver the determined at least one sensing policy candidate to the AF.

The sensing client or the ASP within the sensing client may determine a sensing policy from among the at least one sensing policy candidate (S340).

The core network may receive the determined sensing policy via the first NF (S342) and may deliver it to the second NF (S350).

The core network may apply the determined sensing policy and deliver the sensing policy to the RAN and the UE by using the second NF (S362, S364).

The second NF may transmit sensing configuration information, sensing policy (for example, URSP, or UE route selection policy), target sensing agent, and the like to a sensing controller within the RAN and/or the sensing application (i.e. sensing App) of the UE (S362, S364).

The UE Route Selection Policy (URSP) may be used to determine whether to associate sensing and/or a PDU session to be used for delivery of the sensing result by the UE with an already established PDU session, offload the traffic to a non-3GPP access network other than a PDU session, or request the establishment of a new PDU session. The URSP may include a service and session continuity mode selection policy, a network slice selection policy, a data network name (DNN) selection policy, a non-seamless offloading policy, and an access type preference indicating whether a 3GPP access network or a non-3GPP access network is preferred.

A UE policy including the URSP may be pre-configured in the UE or may be configured by the PCF.

The PCF may distribute the UE policy during a registration procedure of the UE or when the AMF that manages the UE's location or mobility is changed. As another example, the PCF may distribute the UE policy at a time specified by the operator. The UE policy may be divided into policy sections by the PCF and delivered to the UE after being divided.

The UE and the RAN may transmit/receive sensing reference signals and/or sensing measurement results to/from each other (S370).

The sensing measurement analyzer may also be implemented through NF(s) within the core network in addition to the sensing client. For example, the SeMF and SeRF may include the sensing measurement analyzer function.

Further, the NWDAF within the core network may be used to assist or complement the function of the sensing measurement analyzer.

The UE and the RAN may include sensing reference signal transmitter (Tx)/receiver (Rx) modules. The RAN may use various access techniques such as Wi-Fi, New Radio (NR), E-UTRA, and 6G radio to transmit and/or receive sensing reference signals according to the sensing policy delivered from the PCF.

When the UE transmits a sensing reference signal, the UE may operate like a RAN for another UE. The RAN and the UE may include sensing signal analyzers/transporters.

The sensing signal analyzers/transporters may derive meaningful results corresponding to the request from the sensing application or may provide raw measurements to the ASP of the sensing client 360. The sensing results may be delivered directly via a user plane or via a control plane of the core network, such as the SeMF and/or SCEF.

The SeMF may operate as an independent NF or an integrated logical component within the PCF or LMF in the cellular system. The SeMF may implement sensing requests within the cellular system and may combine and analyze the sensing measurement results from the UE and the RAN.

The sensing client function may include the sensing measurement analyzer and the ASP (server). The sensing measurement analyzer may analyze both processed measurements and unprocessed measurements among the collected sensing measurements.

The ASP (server) may perform two roles: initiating negotiation to implement sensing activities in the cellular network and supporting transmission of sensing measurements from the cellular network to the sensing measurement analyzer.

The sensing client may initiate wireless sensing policy negotiation with the cellular network via the AF of the first NF (S314). The negotiation may be started upon receipt of a sensing reservation request from the sensing app of the UE (S310) or upon recognition of a need for a sensing reservation by the ASP (S312).

A motivation for the sensing reservation may originate from, for example, a need for high-precision sensing, which requires excessive resources such as UEs and RANs and imposes a significant burden on the cellular network. The sensing reservation function may refer to a function that distributes such load by scheduling resource-intensive sensing at times of low usage (e.g. midnight).

Second, a user of the ASP may configure specific times and resources for sensing through the sensing app to optimize network usage and efficiency.

The sensing client may implement an algorithm that analyzes changes in sensing results over time using the sensing reservation function. For example, when sensing a single area, the sensing client may reserve a function of performing accurate sensing using all available wireless signals and additional information of the cellular network.

The sensing client may also request real-time sensing with lower accuracy. The sensing client may compare measurement results based on two accuracy levels and analyze a difference therebetween.

The sensing client may determine whether to initiate sensing reservation based on requirements of sensing apps occurring in multiple UEs and internal logic (S312). Once the initiation of sensing reservation negotiation is determined, the sensing client may initiate negotiation for wireless sensing within the cellular network via the AF of the first NF (S314).

During the negotiation process, the sensing client may specify sensing requirements including one or more of the following: desired time window for sensing, level of sensing accuracy, level of sensing resolution, a list of sensing candidates, desired frequency list for the sensing, potential sensing modes (e.g. UE-to-UE, UE-to-RAN, RAN-to-UE, RAN-to-RAN, RAN self, UE self), necessary access techniques, sensing signal intervals, expected number of UEs participating, external group identifier, network area information, and a MAC address or IP 3-tuple to identify the application server. Once the sensing requirements are defined, the sensing client may transmit the sensing requirements to the first NF for further processing (S314).

The sensing time window may include a sensing start time and a sensing end time. In an alternative exemplary embodiment of the present disclosure, a sensing start condition and a sensing end condition may be included in sensing requirements. For example, background sensing may be initiated when a predetermined condition corresponding to an idle state of network traffic is satisfied.

In an exemplary embodiment of the present disclosure, sensing may be initiated when both the sensing start time and the sensing start condition are satisfied. That is, sensing may be initiated when a sensing start time coincides with satisfaction of the idle state condition of the network traffic.

Reservation-based sensing illustrated in FIGS. 3 to 8 may be implemented by applying a part of a background data transfer (BDT) procedure.

In an exemplary embodiment of the present disclosure, the first NF may include the SCEF, and the SCEF may include the AF and the NEF.

The AF may serve as a mediator in the negotiation. Upon receiving the sensing negotiation request from the sensing client, the AF may deliver the sensing negotiation request to the second NF via the NEF (S320). The second NF may include the PCF, and at least some of functions of the SeMF, the SeCF, the AMF, etc. may be included and implemented in the second NF.

During the negotiation process, a response delivered from the second NF (S332) may be transmitted to the sensing client via the NEF and the AF of the first NF (S334). The response transmitted through step 334 may include a list of sensing policies approved for implementation in the cellular network.

The NEF may perform two roles. First, the NEF may convert an external request into a cellular network service request. Second, the NEF may store a sensing request and forward the sensing request to the UDR, tagging specific requirements expressed by the sensing client.

The sensing reservation/negotiation request may be processed by the second NF in the cellular network. In this case, function(s) participating in processing the sensing reservation request in the cellular network may include the PCF and/or the UDR/UDM.

When the sensing reservation/negotiation request is delivered to the PCF, the PCF may access the UDR to store the sensing client's request. Subsequently, the PCF may retrieve all sensing reservation requests stored in the UDR and evaluate applicable sensing policies. The PCF may determine the most appropriate sensing policy based on evaluation results of the applicable sensing policies.

For example, the PCF may integrate similar requests or allocate the requests to an idle time window (i.e. slots) and serve as a load balancer. Once a sensing policy list is made, the PCF may transmit the approved sensing policies to the sensing client via the AF (S334). The sensing client may select a policy most suitable for implementing the sensing from the list (S340), and the selected sensing policy may be transmitted to the second NF including the PCF via the first NF (S342, S350).

The second NF including the PCF may implement the sensing policy in the cellular network (S362, S364). The sensing policies may be implemented in the sensing time window determined for future. The second NF may store the sensing policies in the UDR for the re-utilization of the sensing policies.

FIGS. 4 to 6 are operational flow charts illustrating exemplary embodiments of processes of a reservation-based sensing method and a sensing policy negotiation method for reservation-based sensing according to the present disclosure.

Referring to FIG. 4, when a sensing application of a UE decides to initiate sensing or when a user manually makes a reservation, the UE may transmit sensing requirements to the ASP (S410). The sensing requirements may include a time window for sensing, a target area, a target object, a sensing resolution, and available sensors (e.g. GPS, WiFi, NR, LTE, sidelink, PC5 link, Bluetooth).

The ASP may evaluate whether to reserve cellular sensing based on an individual request of the UE, may integrate multiple requests, or may evaluate its own operational requirements (S420).

If the ASP determines/decides to reserve a sensing function using mobile communication network, the ASP may generate or form a sensing policy for transmission of wanted the sensing requirements to the cellular network (S430). The sensing policy may specify parameters such as a required time window for sensing, a maximum interval between measurements, a target area, a target object, a sensing resolution, and necessary sensing techniques (e.g. access type, frequency).

The sensing policy may also define sensing modes including options such as UE self-sensing using radio wave reflection, RAN self-sensing using radio wave reflection, UE-to-UE sensing, UE-to-RAN sensing, RAN-to-UE sensing, or RAN-to-RAN sensing. The sensing policy may broadly define or describe a measurement reporting method ranging from raw unprocessed data to processed data in which differences exceeding a predefined threshold are highlighted.

The formed sensing policy may be delivered from the ASP to the AF.

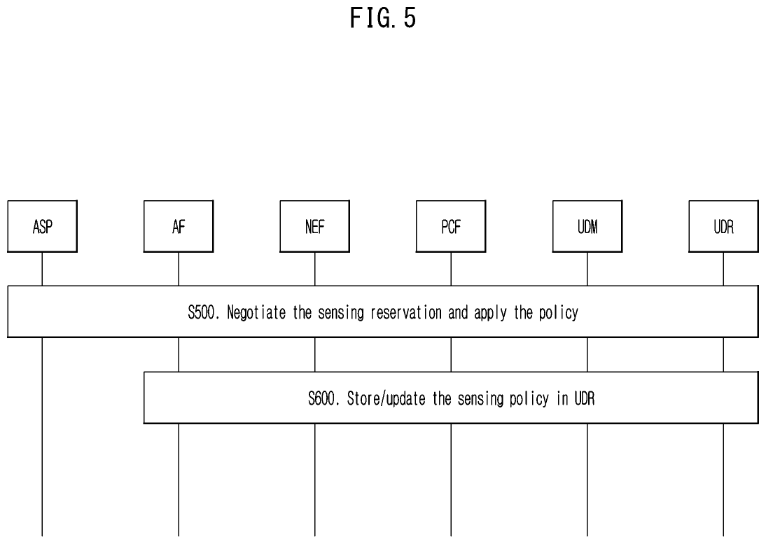

Referring to FIG. 5, the sensing client function may negotiate a sensing policy and time reservations with the first NF including the SCEF and the cellular network, as illustrated in FIGS. 3 and 5 (S500).

When a sensing policy is determined in the negotiation process of step S500, the first NF including the SCEF may store or update the policy in the UDR of the cellular network with support from the second NF including the PCF (S600). The first and/or second NF may determine a list of candidate UEs to participate in sensing that is necessary to implement the policy.

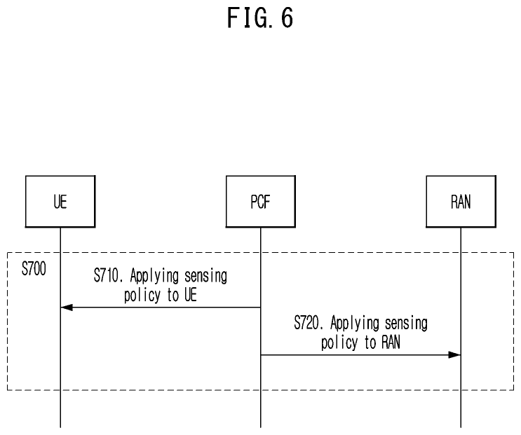

Referring to FIG. 6, once the sensing policy is confirmed in steps S500 and S600, the second NF including the PCF may implement the policy for both the UE and the RAN (S700, S710, S720).

When a reserved sensing time starts and the second NF including the PCF does not hold the sensing policy, the second NF may search and/or retrieve a policy from the UDR before implementation.

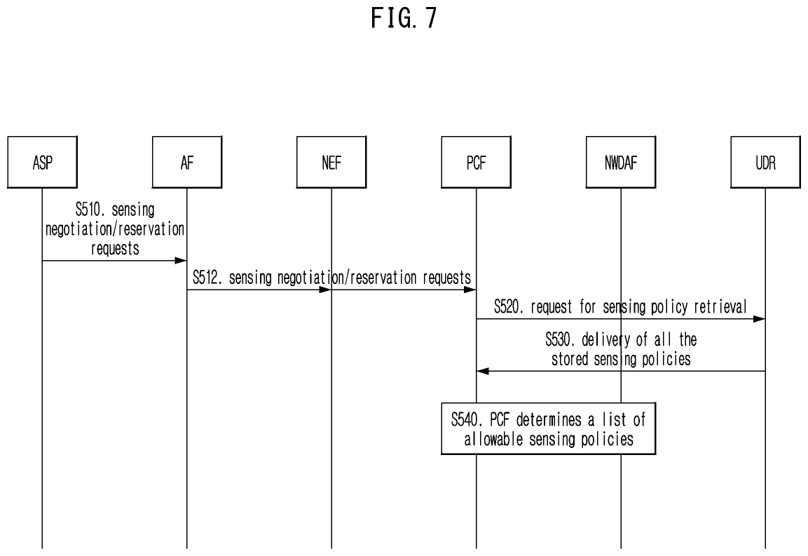

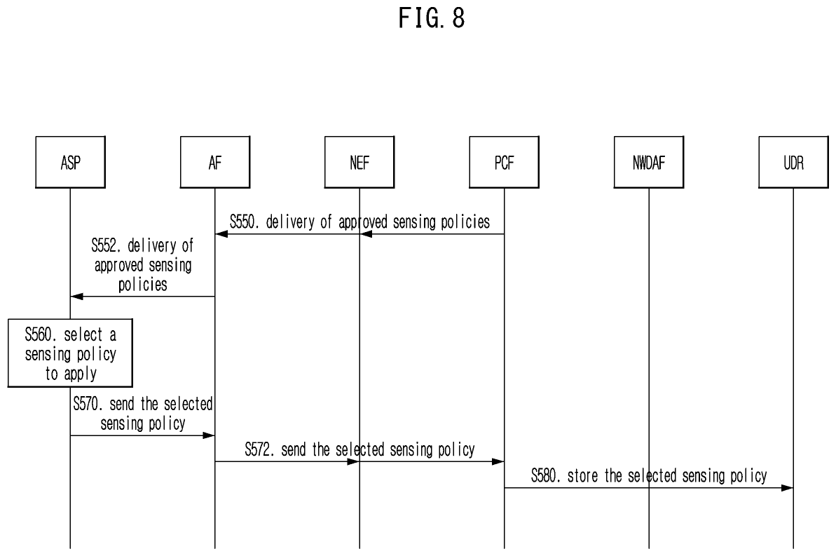

FIGS. 7 and 8 are operational flowcharts illustrating exemplary embodiments of processes of a sensing policy negotiation method for reservation-based sensing according to the present disclosure.

Referring to FIG. 7, when a sensing negotiation/reservation request is received from the ASP of the sensing client (S510), the first NF including the SCEF may initiate a negotiation for sensing reservation.

The sensing negotiation request may include a comprehensive information set, such as a required time window for sensing, levels of sensing accuracy and sensing resolution, potential sensing modes (e.g. UE-to-UE, UE-to-RAN, RAN-to-UE, RAN-to-RAN, RAN self (using the reflected radio wave), and UE self (using the reflected radio wave)), necessary access technologies (e.g. access type, frequency), sensing signal interval or maximum interval between measurements, expected number of participating UEs, external group identifiers, and a target area described in the network.

A report for measurement results may include various types of content, such as area information, a MAC address or IP 3-tuple to identify an application server, and data ranging from raw unprocessed data to processed data in which differences exceeding a predefined threshold are highlighted.

By delivering the sensing negotiation/reservation request to the second NF including the PCF via the first NF including the SCEF (S512), a negotiation procedure within the core network may be initiated.

The second NF including the PCF may request all stored reservation-based sensing policies for all ASPs from the UDR (S520).

The UDR may provide all stored sensing policies in response to the request of step S520 (S530).

The second NF including the PCF may determine a list of sensing policies to be applied, including a reserved time for sensing, based on the sensing policies requested in steps S510 and S512 and the sensing policies retrieved in steps S520 and S530 (S540). The sensing policy list may include at least one sensing policy candidate.

In an alternative exemplary embodiment of the present disclosure, in step S540, the PCF may cooperate with the NWDAF and determine sensing policies by utilizing NWDAF analysis, considering factors such as UE mobility, communication patterns, network performance, distribution, expected WiFi signal strength, and network load.

The second NF including the PCF may serve as a load balancer by integrating similar requests or allocating the requests to idle time windows (e.g. slots) based on the above-described information.

Referring to FIG. 8, the second NF including the PCF may transmit an approval message that specifies a sensing reservation ID, an approved sensing time window, and acceptable/approved sensing policies to the ASP of the sensing client via the first NF including the SCEF (S550, S552).

The ASP of the sensing client may receive the approved sensing policy list and may select one policy from the list (S560). When an update to the selected sensing policy is required, the ASP of the sensing client may adjust a configuration of the ASP server and the sensing application via a user plane.

The ASP of the sensing client may transmit the selected sensing policy and the sensing reservation ID to the second NF including the PCF via the first NF including the SCEF (S570, S572).

The second NF including the PCF may identify and confirm the sensing policy associated with the designated sensing reservation ID.

The second NF including the PCF may store or update the selected sensing policy in the UDR using the sensing reservation ID (S580).

The second NF including the PCF may subscribe to alerts regarding changes to the sensing policy, as illustrated in FIG. 9. When the second NF including the PCF selects to apply the sensing policy locally, the procedure of storing the sensing policy in the UDR may be omitted.

FIG. 9 is an operational flowchart illustrating exemplary embodiments of processes for managing sensing policies for a reservation-based sensing method according to the present disclosure, including storage, update, and removal.

Referring to FIG. 9, a process of applying a final sensing policy to the UE and the RAN during a designated sensing reservation period is illustrated.

Step S610 of FIG. 9 may be replaced with the description of step S430 of FIG. 4. Through step 610, the sensing policy may be determined.

The ASP of the sensing client may identify UE participants for sensing and may transmit a UE participant list along with a sensing reservation ID to the AF. This list may be represented as an external group ID utilized in the first NF including the SCEF.

The AF of the first NF including the SCEF may transmit the sensing reservation ID and the UE participant list represented as an external (group) ID to the NEF. The AF of the first NF including the SCEF may also transmit the sensing policy to the NEF (S620).

The NEF may convert the external ID or the external group ID into an internal ID of the cellular network (e.g. SUPI, GPSI, internal group ID, etc.) and may manage authorization and authentication procedures necessary for storing and/or updating the sensing policy.

The first NF including the SCEF may transmit a request to the UDM to store or update the sensing policy and may register the UE participants for sensing (S630). The request of step S630 may include the sensing reservation ID, the internal group ID, or the UE participant list.

The first NF including the SCEF may access the UDR to store or update the sensing policy (S640). The UDR may receive a message including the sensing reservation ID, the UE participants designated for sensing, or the UE group list, and may store or update the sensing policy indicated in the message in association with the UE participants or the UE group.

The NEF of the first NF including the SCEF may transmit a response to the AF regarding the sensing policy (S650). The message transmitted through step 650 may be a response to the message transmitted through step 620.

When the second network function including the PCF subscribes to information regarding changes to the sensing policy, a notification regarding the update of the sensing policy may be received (S660). In step S660, the UDR may transmit an alarm to notify the change or update of the sensing policy.

The second NF including the PCF may apply the updated sensing policy to the UE using user configuration updates or re-registering the UE.

FIG. 10 is a conceptual diagram illustrating an example of a generalized computing system in which an entity within the core network 100 capable of performing at least a portion of the processes of FIGS. 1 to 9, a sensing entity participating in the sensing process in interaction with the core network 100, or a part thereof may be implemented.

At least some of the processes such as sensing, control, computation, data processing, data transmission, and reception performed by an entity performing at least a part of NFs in the core network 100 and the sensing entity involved in the sensing process for the target according to exemplary embodiments of the present disclosure may be executed by the computing system 1000 of FIG. 10.

Referring to FIG. 10, the computing system 1000 according to an exemplary embodiment of the present disclosure may include a processor 1100, a memory 1200, a communication interface 1300, a storage device 1400, an input interface 1500, an output interface 1600, and a bus 1700.

The computing system 1000 according to an exemplary embodiment of the present disclosure may include the at least one processor 1100 and the memory 1200 that stores instructions causing the at least one processor 1100 to perform at least one step. At least a portion of the steps of the method according to an exemplary embodiment of the present disclosure may be performed by the at least one processor 1100 that loads the instructions from the memory 1200 and executes the instructions.

The processor 1100 may refer to a central processing unit (CPU), a graphics processing unit (GPU), or a dedicated processor on which the methods according to the exemplary embodiments of the present disclosure are performed.

Each of the memory 1200 and the storage device 1400 may include at least one of a volatile storage medium and a non-volatile storage medium. For example, the memory 1200 may include at least one of a read-only memory (ROM) and a random access memory (RAM).

The computing system 1000 may further include the communication interface 1300 for performing communication through a wireless network.

The computing system 1000 may further include the storage device 1400, the input interface 1500, and the output interface 1600.

The respective components included in the computing system 1000 may communicate with one another by being connected via the bus 1700.

A communication network system controlling sensing, (for example, for a target sensing area, object, and/or event) according to an exemplary embodiment of the present disclosure, may include at least one entity, and the at least one entity may include the computer-readable memory 1200 storing at least one instruction, and the processor 1100 executing the at least one instruction.

The at least one entity may receive a sensing request (for example, related to a target sensing area, object, and/or event) from the sensing client (S314), may negotiate a sensing policy for performing a sensing operation corresponding to the sensing request with the sensing client using at least one NF (S320, S330, S340, S350), and may communicate with a RAN or a UE using the at least one NF, so that the sensing operation corresponding to the sensing request is performed by applying the sensing policy determined based on the negotiation (S362, S364).

In this case, the sensing request may include reservation information for performing the sensing operation.

An example of the computing system 1000 of the present disclosure may include a communicable desktop computer, laptop computer, notebook, smartphone, tablet PC, mobile phone, smart watch, smart glasses, e-book reader, portable multimedia player (PMP), portable gaming device, navigation device, digital camera, digital multimedia broadcasting (DMB) player, digital audio recorder, digital audio player, digital video recorder, digital video player, or personal digital assistant (PDA), and/or the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A communication system for providing a reservation-based sensing function, comprising at least one entity,
wherein the at least one entity comprises:
a computer-readable memory storing at least one instruction; and
a processor executing the at least one instruction, and
wherein the at least one entity is configured to:
receive, from a sensing client, a sensing request;
negotiate, by using at least one network function (NF), a sensing policy for performing a sensing operation corresponding to the sensing request with the sensing client; and
communicate with a radio access network (RAN) or a user equipment (UE) using the at least one NF, so that the sensing operation corresponding to the sensing request is
performed by applying the sensing policy determined based on the negotiation, and
wherein the sensing request includes reservation information for performing the sensing operation.

2. The communication system according to claim 1, wherein the at least one entity is further configured to:
transmit, through at least one first NF, a sensing reservation or negotiation request including the reservation information to at least one second NF;
determine, through the at least one second NF, at least one sensing policy candidate in response to the sensing reservation or negotiation request; and
transmit, through the at least one first NF, the at least one sensing policy candidate to the sensing client as a response to the sensing reservation or negotiation request.

3. The communication system according to claim 2, wherein the at least one entity is further configured to: receive, through the at least one first NF, the sensing policy determined by the sensing client among the at least one sensing policy candidate, in response to the sensing reservation or negotiation request.

4. The communication system according to claim 2, wherein the at least one entity is further configured to: determine, using a Network Data Analytics Function (NWDAF), the at least one sensing policy candidate in response to the sensing reservation or negotiation request, for determining of the at least one sensing policy candidate.

5. The communication system according to claim 1, wherein the sensing policy includes information on at least one of a condition or time when sensing is initiated, a condition or time when sensing ends, available resources for sensing, sensing accuracy, sensing resolution, available sensing modes, an interval between sensings, or UE(s) capable of participating in sensing.

6. The communication system according to claim 1, wherein the at least one entity is further configured to:
exchange, via at least one first NF, at least one sensing policy candidate for performing the sensing operation corresponding to the sensing request between at least one second NF and the sensing client; and
communicate, using the at least one second NF, with the RAN or the UE, so that the sensing operation corresponding to the sensing request is performed by applying the sensing policy determined based on the negotiation.

7. The communication system according to claim 1, wherein the at least one entity is further configured to: retrieve, using a Unified Data Management (UDM) or a Unified Data Repository (UDR), an available sensing policy candidate capable of responding to the sensing request, in order to negotiate the sensing policy with the sensing client.

8. The communication system according to claim 1, wherein the at least one entity is further configured to: store and manage, using a Unified Data Management (UDM) or a Unified Data Repository (UDR), the sensing policy determined based on the negotiation.

9. The communication system according to claim 8, wherein the at least one entity is further configured to: update or remove, using at least one first NF, the UDM or the UDR, a previously stored sensing policy based on the sensing policy determined based on the negotiation.

10. The communication system according to claim 8, wherein the at least one entity is further configured to: notify, using the UDM or the UDR, at least one second NF of a change to a previously stored sensing policy in accordance with the sensing policy determined based on the negotiation.

11. A sensing policy negotiation method for reservation-based sensing, comprising:
receiving, by a core network and using at least one first network function (NF), a sensing reservation or negotiation request from a sensing client;
determining, by the core network and using at least one second NF, at least one sensing policy candidate in response to the sensing reservation or negotiation request; and
transmitting, by the core network and using the at least one first NF, the at least one sensing policy candidate to the sensing client as a response to the sensing reservation or negotiation request.

12. The sensing policy negotiation method according to claim 11, further comprising: receiving, by the core network and using the at least one first NF, a sensing policy, among the at least one sensing policy candidate, determined by the sensing client as a result of the sensing reservation or negotiation request.

13. The sensing policy negotiation method according to claim 12, further comprising: communicating, by the core network and using the at least one second NF, with a Radio Access Network (RAN) or a User Equipment (UE) so that sensing is performed by applying the sensing policy determined as the result of the sensing reservation or negotiation request.

14. The sensing policy negotiation method according to claim 11, wherein the at least one sensing policy candidate includes information on at least one of a condition or time when sensing is initiated, a condition or time when sensing ends, available resources for sensing, sensing accuracy, sensing resolution, available sensing modes, an interval between sensings, or UE(s) capable of participating in sensing.

15. The sensing policy negotiation method according to claim 11, wherein the determining of the at least one sensing policy candidate comprises: determining, by the core network and using a Network Data Analytics Function (NWDAF), the at least one sensing policy candidate in response to the sensing reservation or negotiation request.

16. A reservation-based sensing method comprising:
receiving, by a core network and using at least one first network function (NF), a sensing request from a sensing client;
negotiating, by the core network and using at least one second NF, a sensing policy for performing a sensing operation corresponding to the sensing request with the sensing client; and
communicating, by the core network and using the at least one second NF, with a radio access network (RAN) or a user equipment (UE), so that the sensing operation corresponding to the sensing request is performed by applying the sensing policy determined based on the negotiation,
wherein the sensing request includes reservation information for performing the sensing operation.

17. The reservation-based sensing method according to claim 16, wherein the negotiating of the sensing policy with the sensing client comprises: exchanging, by the core network and via the at least one first NF, at least one sensing policy candidate for performing the sensing operation corresponding to the sensing request between the at least one second NF and the sensing client.

18. The reservation-based sensing method according to claim 16, further comprising: retrieving, by the core network and using a Unified Data Management (UDM) or a Unified Data Repository (UDR), an available sensing policy candidate capable of responding to the sensing request, in order to negotiate the sensing policy with the sensing client.

19. The reservation-based sensing method according to claim 16, further comprising: storing and managing, by the core network and using a Unified Data Management (UDM) or a Unified Data Repository (UDR), the sensing policy determined based on the negotiation.

20. The reservation-based sensing method according to claim 16, wherein the sensing request includes information on at least one of a condition or time when sensing is initiated, a condition or time when sensing ends, available resources for sensing, sensing accuracy, sensing resolution, available sensing modes, an interval between sensings, or UE(s) capable of participating in sensing.
